(19) United States
(12) Patent Application Publication
(10) Pub. No.: US 2026/0109397 A1
(43) Pub. Date: Apr. 23, 2026

(54) METHODS AND APPARATUS FOR OPERATING AN ELECTRICALLY POWERED MOTOR VEHICLE

(71) Applicant: Ford Global Technologies, LLC, Dearborn, MI (US)

(72) Inventors: Alexander Ein Waldt, Köln (DE); Sergio Codonesu, Aachen (DE); Goetz-Philipp Wegner, Dortmund (DE); Oliver Nehls, Düsseldorf (DE); Gerhard Friederich, Bornheim (DE)

(21) Appl. No.: 19/331,522

(22) Filed: Sep. 17, 2025

(30) Foreign Application Priority Data
Oct. 21, 2024 (DE) 102024130575.4

(51) Int. Cl. B62D 5/04; B60L 1/00; B60L 58/13

(52) U.S. Cl. CPC B62D 5/0463; B60L 1/003; B60L 58/13

(57) ABSTRACT

The disclosure generally relates to an electrically powered motor vehicle and, more particularly to, methods and apparatus for operating an electrically powered motor vehicle. An example method for operation of a vehicle includes applying torque to a steering wheel of the vehicle while the vehicle is in a deactivated mode to generate electrical energy in an electric motor of the vehicle, and charging an energy storage device of the vehicle with the generated electrical energy.

### RELATED APPLICATION

This patent claims priority from DE Patent Application Number 102024130575.4, which was filed on Oct. 21, 2024, and is hereby incorporated by reference in its entirety.

### FIELD OF THE DISCLOSURE

The disclosure generally relates to an electrically powered motor vehicle and, more particularly to, methods and apparatus for operating an electrically powered motor vehicle.

### BACKGROUND

Steer-by-wire steering systems (hereinafter SBW steering systems) are a steering technology in which the direct mechanical connection between the steering wheel and the road wheel is eliminated and replaced by two actuators: a steering wheel actuator with feedback, which generates feedback torque for the driver at the steering wheel, and a road wheel actuator, which moves at least one, but typically several, steerable road wheels to a desired position.

### SUMMARY

An example method for operation of a vehicle includes applying torque to a steering wheel of the vehicle while the vehicle is in a deactivated mode to generate electrical energy in an electric motor of the vehicle, and charging an energy storage device of the vehicle with the generated electrical energy.

An example apparatus for a vehicle includes an electric motor coupled to a steering wheel, where a torque applied to the steering wheel while the vehicle is in a deactivated mode causes electrical energy to be generated, and a control device configured to cause a energy storage device of the vehicle to be charged by the generated electrical energy, and causing main contactors of the vehicle to close when a state of charge of the energy storage device exceeds a first threshold.

An example non-transitory computer readable storage medium includes instructions to cause programmable circuitry to at least cause an energy storage device of a vehicle to be charged by electrical energy generated by a torque applied to an electric motor, and causing main contactors of the vehicle to close when a state of charge of the energy storage device exceeds a first threshold.

### BRIEF DESCRIPTION OF DRAWINGS

FIG. 1 is a representation of a motor vehicle with an example assembly according examples described herein.

FIG. 2 is a flowchart representative of example machine readable instructions and/or example operations that may be executed, instantiated, and/or performed by example programmable circuitry to implement the assembly of FIG. 1.

FIG. 3 is a block diagram of an example processing platform including programmable circuitry structured to execute, instantiate, and/or perform the example machine readable instructions and/or perform the example operations of FIG. 2 to implement the assembly of FIG. 1.

In general, the same reference numbers will be used throughout the drawings and accompanying written description to refer to the same or like parts. The figures are not necessarily to scale.

### DETAILED DESCRIPTION

Electrically powered motor vehicles typically include an on-board electrical system including a high-voltage battery electrical system and a low-voltage electrical system. In general, the on-board electrical system has a DC-DC converter that can be used to transmit electrical energy from the high-voltage electrical system to the low-voltage electrical system and vice versa. In general, the high-voltage battery has separating (e.g., isolating) agents for example, main contactors, to be able to separate the high-voltage battery from other components of the on-board electrical system. The activation and deactivation (e.g., closing and opening) of the main contactors is enabled by components of the low-voltage electrical system, for example by a battery management unit.

After long periods of inactivity of the vehicle or due to previous operating conditions, the corresponding energy storage devices of the low-voltage electrical system can be relatively discharged and therefore the battery management unit can no longer be operated. In such examples, the state of charge of energy storage devices of the low-voltage on-board electrical system can be too low to operate the DC-DC converter required to charge components of the low-voltage electrical system using the high-voltage battery. In addition, the state of charge of the high-voltage battery, for example after long periods of idleness, can be too low to charge components of the low-voltage electrical system. Accordingly, there are operational situations in which the battery management unit can no longer guarantee the operation of the main contactors (e.g., the opening and closing of the main contactors). If the main contactors cannot be closed, the motor vehicle cannot be operated, nor can the high-voltage battery be charged by an external charging current because it is electrically separated from the rest of the vehicle's electrical system (e.g., also from a charging device).

Known solutions require a driver of the vehicle to use an external power source such as a power bank or a charger to charge components of the low-voltage electrical system. Afterwards, the main contactors can be closed again (e.g., activated). However, such an external power source is not always readily available. There is therefore a need to eliminate or at least reduce the disadvantages of known processes and assemblies for the operation of an electrically powered motor vehicle.

Examples disclosed herein eliminate or at least reduce the disadvantages of known processes and assemblies for the operation of an electrically powered vehicle. An example method disclosed herein relates to operating an electrically powered motor vehicle. The motor vehicle includes at least one high-voltage battery, a low-voltage electrical system with at least one energy storage device, a DC-DC converter operatively coupled between the high-voltage battery and the low-voltage electrical system, a steering wheel with a steering wheel actuator coupled to the steering wheel, and a battery management unit. The battery management unit is at least coupled to the DC-DC converter and the steering wheel actuator. The method includes at least the following operations. In a first operation, the steering wheel is subjected to torque by the driver in a deactivated mode of the motor vehicle, which causes the steering wheel to rotate, so that electrical energy is recuperated in an electric motor of the steering wheel actuator for the low-voltage electrical system. In a second operation, the battery management unit is charged with the recuperated electrical energy until the battery management unit has a state of charge greater than an initial charge threshold. In a third operation, the energy storage device is charged with the recuperated electrical energy until the energy storage device has a state of charge greater than a second charging threshold. Further, in a fourth operation, the battery management unit is supplied with a supply current by the energy storage device after the second charging threshold has been exceeded.

The example method is based on the finding that the steering wheel of a steer-by-wire (SBW) steering system of the electrically powered motor vehicle can be used as a power generator if the electric motor of the steering wheel actuator coupled to the steering wheel is used in accordance with a generator function. The driver of the motor vehicle then only needs to exert a mechanical torque on the steering wheel in such a way that a steering wheel rotation is caused. This generates an electromagnetic counter-field within the electric motor of the steering wheel actuator, which enables the mechanically applied torque to be converted into electrical energy. The electrical energy generated in this way can be used either to supply the battery management unit directly with electricity, or to first charge an energy storage device of the low-voltage on-board electrical system, which in turn supplies the battery management unit with a supply current. As a result, it can be generally ensured that the battery management unit is supplied with sufficient power to be able to control the main contactors, even though the motor vehicle is generally deactivated. This circumvents the need for an external charging current, for example via a power bank or an external charger, to ultimately ensure the functionality of the main contactors. The driver of the vehicle does not need to consider any external components to be able to restore the functionality of the vehicle. For example, the driver of the vehicle does not need to have any knowledge of the necessary coupling of the vehicle with an external charger. It must be considered here that the coupling with the external charger typically cannot be carried out via the regular charging interface of the electrically powered vehicle according to previous approaches.

Examples described herein further provide for an assembly for an electrically powered vehicle. The assembly includes at least a high-voltage battery, a low-voltage electrical system with at least one energy storage device, a DC-DC converter operatively coupled between the high-voltage battery and the low-voltage electrical system, a steering wheel with a steering wheel actuator coupled to the steering wheel, and a battery management unit. The battery management unit is at least coupled to the DC-DC converter and the steering wheel actuator. In an electric motor of the steering wheel actuator, electrical energy for the low-voltage electrical system can be recuperated (e.g., generated) for the low-voltage electrical system as a result of a driver torque applied to the steering wheel in a deactivated mode of the vehicle. The battery management unit and/or the energy storage device can be charged with the generated electrical energy. Accordingly, the battery management unit can be supplied with a supply current through the energy storage device.

The advantages achieved by the example process described herein are also achieved in a corresponding manner by the example assembly.

A high-voltage storage unit is understood here as a storage unit that typically has several battery modules and has a total voltage amplitude of more than 200 V (e.g., 400 V, 800 V, etc.).

The low-voltage electrical system includes components of the vehicle that have a nominal voltage amplitude of 60 V or less (e.g., 48 V, 24 V, 12 V, 5 V, etc.). The low-voltage electrical system can supply vehicle systems with different nominal voltage amplitudes.

The energy storage device of the low-voltage electrical system can, in some examples, be a low-voltage battery or a capacitor (e.g., storage capacitor) that has a nominal voltage amplitude of 60 V or less (e.g., 12 V, 16 V, 18 V, 24 V, 48 V, etc.).

The energy storage device can still have a residual state of charge before the generated energy is used to charge the energy storage device. However, the residual state of charge may not be sufficient to provide a supply current for the battery management unit. In such examples, the energy storage device has a residual state of charge, but the main contactors cannot be closed (e.g., activated) by the battery management unit.

In some examples, the DC-DC converter is configured for power conversion between the high-voltage electrical system and the low-voltage electrical system. The high-voltage electrical system includes at least the high-voltage battery.

Alternatively, the DC-DC converter is configured for unidirectional current conversion between the high-voltage electrical system and the low-voltage electrical system, starting from the high-voltage storage unit to the low-voltage on-board electrical system.

In some examples, the steering wheel actuator is not directly coupled to the steering wheel, but only indirectly to the steering wheel, for example via a steering column.

In some examples, the steering wheel actuator is part of a SBW steering system of the electrically powered vehicle.

The SBW steering system of the motor vehicle is to be understood here as a conventional SBW steering system of the motor vehicle, and not an auxiliary steering system, which is only made possible by torque control with regard to drive units (e.g., motors) and/or deceleration devices (e.g., wheel brakes) assigned to the respective road wheels, not a tertiary lateral control (TLC). In this context, the drive units here are to be understood as correspondingly operated electric motors, each of which is assigned to at least one road wheel and serves to drive the motor vehicle, but not (e.g., primarily) to guide the vehicle laterally. Rather, the drive units are separate from the road wheel actuators and their electric motors.

The SBW steering system includes at least one road wheel actuator coupled to at least one steerable road wheel. In some examples, the road wheel actuator can also be coupled at the same time, at least indirectly, with several steerable road wheels, for example via a steering rack.

Alternatively or additionally, the motor vehicle can have several road wheel actuators, each individually coupled with several steerable road wheels.

In some examples, the motor vehicle can also have separate individual road wheel actuators regarding at least some of the motor vehicle's steerable road wheels. This means that the corresponding steerable road wheels can be controlled independently of other steerable road wheels for the lateral guidance of the motor vehicle according to individual wheel orientations. This makes it possible, for example, for individual steerable road wheels to have different orientations, for example a toe-in position with respect to a track position defined by the driver's steering input.

In some examples, the lateral control of the motor vehicle can be based on steering instructions given by the driver, for example via the steering wheel, to steer the vehicle in a specific direction.

Under normal operating conditions of the SBW steering system, the steering actuator is used to give the driver of the vehicle feedback on the lateral control of the vehicle by providing a feedback torque. For example, the rack and pinion force applied to a rack of the SBW steering system is recorded. The rack is at least indirectly coupled to steerable road wheels and thus causes a reorientation of the orientation of the steerable road wheels when deflected from a reference position, for example a zero position. The rack and pinion force can therefore be used to characterize the condition of the vehicle regarding the vehicle lateral guidance, whereby the corresponding feedback torque can be determined. Alternatively, a steering model of the SBW steering system can be used to determine the feedback torque, the main input variables of which are the vehicle speed and wheel angles. Vehicle speed can be detected or determined using speed sensors and/or position signal receivers. The wheel angles are recorded using wheel angle sensors that are configured to detect the alignment (e.g., orientation) of the steerable road wheels. For example, the wheel angle sensors can also detect a rack and pinion position, as this is at least indirectly coupled to the steerable road wheels. As a result, the steering wheel actuator applies a feedback torque to the driver corresponding to the lateral guidance of the motor vehicle. As a result, in the normal operating state of the SBW steering system, the driver can react according to the torque feedback with adapted steering instructions to ensure vehicle control.

In some examples, the assembly includes main contactors. The main contactors allow the high-voltage battery to be electrically separated from the DC-DC converter.

In some examples, the main contactors of the vehicle are closed (e.g., activated) by the battery management unit, allowing a current flow between the high-voltage storage unit and the DC-DC converter. When the state of charge of the battery management unit and/or the state of charge of the energy storage device of the low-voltage electrical system are sufficient, the battery management unit can be used again to control the main contactors. While the high-voltage battery is electrically separated from the DC-DC converter by the main contactors before the main contactors are activated, the activation of the main contactors leads to the release of a current flow in between. As a result, electrical energy can be transferred between the high-voltage on-board electrical system and the low-voltage on-board electrical system via the DC-DC converter. In this way, the partial electrical systems of the vehicle's overall electrical system can be brought back into electrical coupling with each other. In some examples, the energy storage device of the low-voltage electrical system is charged by the high-voltage battery via the DC-DC converter. In such example, it is assumed that the high-voltage battery has a sufficient state of charge to be able to charge the energy storage device of the low-voltage on-board electrical system. As a result, the state of charge of the energy storage device can be increased again.

In some examples, both the energy storage device and the high-voltage battery can be charged using an external charging current due to the closed (e.g., activated) main contactors. Since the main contactors, if activated, allow a current flow between the high-voltage electrical system and the low-voltage electrical system, all components of the vehicle can also be recharged by an external charging current. When the main contactors are deactivated (e.g., open), it is not possible to charge the high-voltage battery, as it is separated from the rest of the vehicle's electrical system.

In some examples, the main contactors are open when the main contactors are without power (e.g., deactivated). This reduces the energy required to disconnect the high-voltage battery from the rest of the vehicle's electrical system. In addition, this means that the main contactors are forcibly opened in the event of inoperability of the low-voltage electrical system, thus disconnecting the high-voltage battery from the rest of the vehicle's electrical system. In some examples, other systems (e.g., secondary systems) of the low-voltage electrical system are supplied with a supply current by the energy storage device when the state of charge of the energy storage device has exceeded a third charging threshold. If sufficient energy is generated or if the energy storage device is charged by the high-voltage battery in the meantime, other devices of the low-voltage on-board electrical system can also be supplied with a supply current. In this way, additional functions of the vehicle can be reactivated.

In some examples, the first charging threshold, the second charging threshold, and the third charging threshold can be the same or different depending on the desired control algorithm. In some examples, the vehicle can be started as soon as the state of charge of the energy storage device exceeds a first operating charge threshold and the state of charge of the high-voltage battery does not fall below a second operating charge threshold. In such examples, both the high-voltage electrical system has a sufficient amount of energy and the low-voltage electrical system has a sufficient amount of energy for the vehicle to be used for driving purposes.

The low-voltage electrical system may also include a control device (e.g., electronical control unit (ECU)) that exercises a charging strategy in accordance with examples described herein. The control device can be internal to the battery management unit or separate from it. In some examples, the control device can generally ensure that when sufficient energy is generated either the battery management unit is directly supplied with the generated energy or an energy storage device of the low-voltage electrical system is first charged. The control device then generally ensures that the energy stored in the energy storage device is then used to power the battery management unit. In this way, the control of the main contactors can be substantially ensured.

In some examples, the method is configured as a computer-implemented method. This means that the operations can be performed by one or more data processing devices. In some examples, a data-processing device of a control device can trigger or execute the corresponding operations. In some examples, the disclosure also relates to a computer program product, comprising commands which, when executed by a computer, cause the computer to execute the method as described herein. The benefits achieved by the method described herein are also achieved in a corresponding manner by the computer program product.

In some examples, the method is implemented by a computer-readable storage medium, comprising commands which, when executed by a computer, cause the computer to execute the method as described herein. The advantages achieved by the method described herein are also achieved in a corresponding way by the computer-readable storage medium.

Examples described herein further provide for an electrically driven vehicle including an assembly as described herein or with an assembly operable by the method as described herein.

The advantages achieved by the method described herein are also achieved in a corresponding manner by the electrically driven vehicle.

For the purposes of the disclosure, vehicles may include land vehicles, namely, inter alia, off-road and road vehicles such as passenger cars, buses, trucks and other commercial vehicles. Vehicles can be manned or unmanned. The vehicles are at least partially electrically driven (e.g., have an electric motor that serves as the drive). In addition, the vehicles can also have a combustion engine.

All the features explained regarding the described examples can be combined individually or in any sub-combination with other aspects.

Each example described in this disclosure is intended only as an example or illustration and should not be construed as favored or advantageous over other examples. The illustrative examples contained herein do not claim to be exhaustive and do not limit the claimed subject matter to the exact disclosed forms. Various variations of the embodiments described are readily recognizable to the skilled person and the general principles defined herein can be applied to other examples and applications without departing from the spirit and scope of the examples described. Therefore, the examples described are not limited to the examples shown but have the widest possible scope of application that is compatible with the principles and characteristics disclosed herein.

All features disclosed below in relation to the examples and/or accompanying figures may be combined, alone or in any sub-combination, with features of the aspects of disclosure provided that the resulting combination of features is reasonable to a skilled person in the field of technology.

For the purposes of disclosure, the phrase “at least one of A, B and C” means, for example, (A), (B), (C), (A and B), (A and C), (B and C) or (A, B and C), including all other possible combinations if more than three elements are listed. In other words, the term “at least one of A and B” generally means “A and/or B”, namely “A”alone, “B”alone or “A and B”.

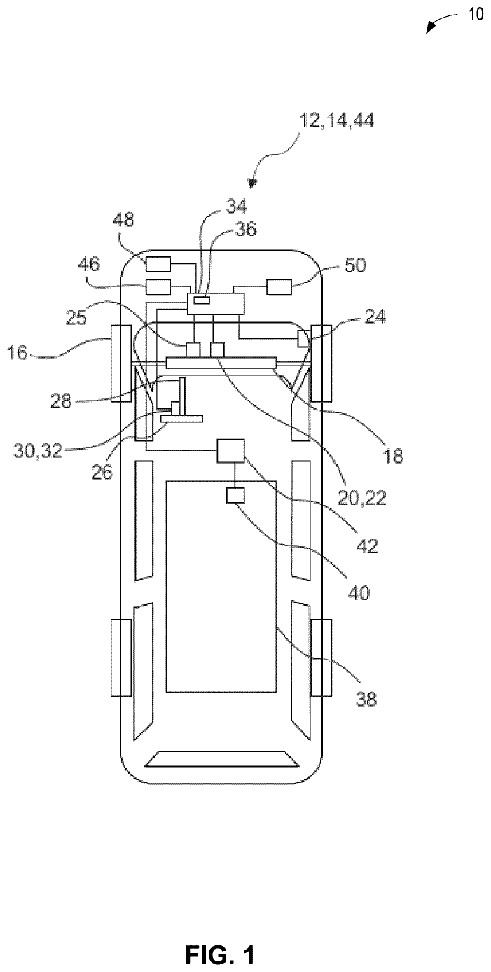

FIG. 1 shows a representation of an example electrically powered motor vehicle (e.g., vehicle) 10 with an assembly 12. The assembly 12 of the vehicle 10 includes a SBW steering system 14 with steerable road wheels 16. The steerable road wheels 16 are coupled to a common rack (e.g., rack, steering rack) 18. The common rack 18 can be moved from a reference position, for example a zero position, which causes a steering movement of the steerable road wheels 16. For example, the steerable road wheels 16 can be deflected starting from a straight alignment of motor vehicle 10 so that motor vehicle 10 follows a curved path.

For the movement of the rack 18, the SBW steering system 14 includes a single road wheel actuator 20 according to the depicted example, which can jointly influence the alignment of both steerable road wheels 16 (e.g., front wheels) of the motor vehicle 10. In the present example, the road wheel actuator 20 is coupled with the rack 18. Alternatively, the road wheel actuator 20 can also be coupled to the steerable road wheels 16 in other ways to influence their orientation.

In some examples, several road wheel actuators 20 can also be provided, each individually coupled to a steerable road wheel 16. This has the advantage that the road wheels 16 are not moved together, which means that the road wheels 16 can be aligned individually. For example, individual road wheels 16 can then take on dedicated out-of-lane positions, for example for specific driving situations (off-road driving). Out of lane position means that the road wheels 16 are not aligned according to the nominal track position, which is defined by the driver's steering input.

Even if not shown in the example of FIG. 1, the vehicle 10, the assembly 12, and the SBW steering system 14 can also have other steerable road wheels 16, such as rear wheels, which are coupled with an additional common rack or with individual road wheel actuators 20.

Each road wheel actuator 20 includes an electric motor 22. The electric motor 22 includes at least one winding set that includes a group of windings. Each winding set is configured so that phase currents are conducted through the underlying windings when they are exposed to supply signals, such as phase voltages, which can be used to drive a rotor of the electric motor 22. The rotor can then be coupled with a corresponding component of the SBW steering system 14, such as the rack 18, and thus enable the movement of the steerable road wheels 16. In some examples, the electric motor 22 can also include more than one winding set. Typically, each winding set is three-phase, so that the electric motor 22 is configured to include at least three-phases, in some examples, also six-phases or nine-phases. If there are several winding sets, the winding sets allow the rotor of the electric motor 22 to move independently of other winding sets. This means that the winding sets are separate from each other.

According to the depicted example of FIG. 1, the module 12 includes wheel sensors 24, for example speed sensors, which can be used to individually record the speeds of the road wheels 16 in the circumferential direction (e.g., rolling direction). Based on the recorded speeds, for example, the wheel-specific slip and the vehicle speed can be determined.

In addition, according to the depicted example of FIG. 1, the module 12 also includes wheel angle sensors 25, which are configured to record the orientation and alignment of the steerable road wheels 16 at least indirectly. For this purpose, the wheel angle sensors 25 are coupled to the rack 18 and record their lateral translation about a reference position, for example the zero position (e.g., center position). Other arrangements of the wheel angle sensors 25 are also conceivable, such as direct coupling with parts of the steerable road wheels 16. This allows the instantaneous angular position of the steerable road wheels 16 with respect to the vehicle's vertical axis to be determined.

After determining the wheel-specific slip and/or the angular position of the steerable road wheels 16, a respective driving condition of the vehicle 10 can be determined, including the lateral guidance of the vehicle 10. This makes it possible to give feedback to the driver of the vehicle 10 about the lateral guidance of the vehicle 10, for example on a steering wheel 26 of the SBW steering system 14 via a feedback torque.

Using the steering wheel 26, a driver of the vehicle 10 can then input steering instructions for the motor vehicle 10 in response to the feedback torque provided at the steering wheel 26 by the SBW steering system 14 to steer the vehicle 10 in a desired direction.

The steering wheel 26 is coupled to a steering column 28 of the SBW steering system 14. The steering column 28 defines the axis of rotation around which the steering wheel 26 can be rotated.

A steering wheel actuator 30 of the SBW steering system 14 is coupled to the steering wheel 26. The steering wheel actuator 30 includes another electric motor 32. The electric motor 32 of the steering wheel actuator 30 also includes at least one winding set. Each electric motor 32 winding set is three-phase and configured to drive an electric motor rotor. As a result, feedback torque can be provided to the driver on the steering wheel 26 of the motor 10 by the electric motor 32 to give the driver feedback regarding the lateral control of the vehicle 10.

The SBW steering system 14 also includes at least one steering wheel sensor, which is not shown, coupled to the steering wheel 26. Each steering wheel sensor is configured independently of other steering wheel sensors to detect a driver's steering preset based on a steering wheel angle (e.g., rotation angle) and/or steering wheel speed of the steering wheel 26 compared to a reference position.

For example, the steering wheel sensor can be coupled to steering column 28, because steering wheel 26 is rigidly coupled to steering column 28 and a rotation of steering wheel 26 thus translates directly into a rotation of steering column 28.

In some examples, the steering wheel sensor can also be coupled with the steering wheel 26 itself, for example with a basic component of the steering wheel 26, instead of with the steering column 28. In such examples, the steering wheel sensor can immediately detect the rotation of the steering wheel 26.

In accordance with the depicted example, the assembly 12 includes a control device 34 with a data processing device 36. In general, the control device 34 can also be a control device of the SBW steering system 14.

In addition, the assembly 12 includes at least one high-voltage storage system (e.g., high-voltage battery system, high-voltage storage device) 38. The high-voltage battery 38 includes internal main contactors 40. In addition, the high-voltage battery system 38 is coupled with at least one direct current to direct current (DC-DC) converter 42. The main contactors 40 are arranged between the high-voltage battery system 38 and the DC-DC converter 42. The main contactors are open without electricity (e.g., normally open). When open, the main contactors prevent current flow between the high-voltage storage system 38 and the DC-DC converter 42. The main contactors can be closed (e.g., activated) via a corresponding control current. Then a current flow between the high-voltage battery system 38 and the DC-DC converter 42 is possible.

According to the depicted example, the high-voltage battery system 38 has a nominal voltage amplitude of 200 V or greater (e.g., 400 V, 600 V, 800 V, etc.).

Furthermore, the assembly 12 includes a low-voltage electrical system 44. The low-voltage electrical system 44 includes components which, according to the depicted example, have a nominal voltage amplitude in the range between 5 V and 48 V. At least the control device 34, the wheel sensors 24, and the steering wheel sensors not shown are part of the low-voltage electrical system 44.

In some examples, the entire SBW steering system 14 can be part of the low-voltage electrical system 44. In some examples, however, it may also be necessary to supply the electric motors 22, 32 of the road wheel actuator 20 or the steering wheel actuator 30 with high-voltage voltages and voltage amplitudes of greater than 60 V.

According to the depicted example, assembly 12 also includes a battery management unit 46, an energy storage device 48 of the low-voltage electrical system 44 and a starter unit 50, which are coupled with the control device 34.

According to the depicted example, the battery management unit 46 is separate from the control device 34. While the battery management unit 46 regulates current flows within the low-voltage electrical system 44, in relation to the high-voltage storage system 38, between these units via the DC-DC converter 42 and also the functioning of the main contactors 40, the control device 34 takes over further control functions, for example with regard to the SBW steering system 14.

In some examples, the battery management unit 46 can also take over the corresponding control functions only indirectly and then output corresponding control signals to the control device 34, which ultimately regulates the corresponding current flows.

In some examples, the battery management unit 46 can be part of the control device 34. In such example, the energy storage device 48 is part of the low-voltage electrical system 44 and is configured as a low-voltage battery. According to this example, the energy storage device 48 has a voltage amplitude of 12 V, 24 V or 48 V. The energy storage device 48 is equipped to provide supply signals for the power supply of components of the low-voltage electrical system 44.

A starter unit 50 is also part of the low-voltage electrical system 44. It can be configured, for example, to regulate current flows so that the electrically powered motor vehicle 10 can be used for propulsion under normal operating conditions. For this purpose, an electric motor intended for propulsion (not shown) must be supplied with supply signals. This requires that various components of the motor vehicle 10 are subjected to appropriate voltage and current amplitudes in a specific sequence and with supply signals. The starter unit 50 accomplishes these control functions in this example, at least indirectly. In some examples, these control functions can also be performed by other components.

In an alternative, the starter unit 50 can also output corresponding control signals to the control device 34, which ultimately enables the corresponding current flows.

In another alternative, the starter unit 50 can also be part of the control device 34.

In some examples, the assembly 12 and the SBW steering system 14 can also include several components of the same type and generally the same function, for example several wheel sensors 24, which ensures redundancy.

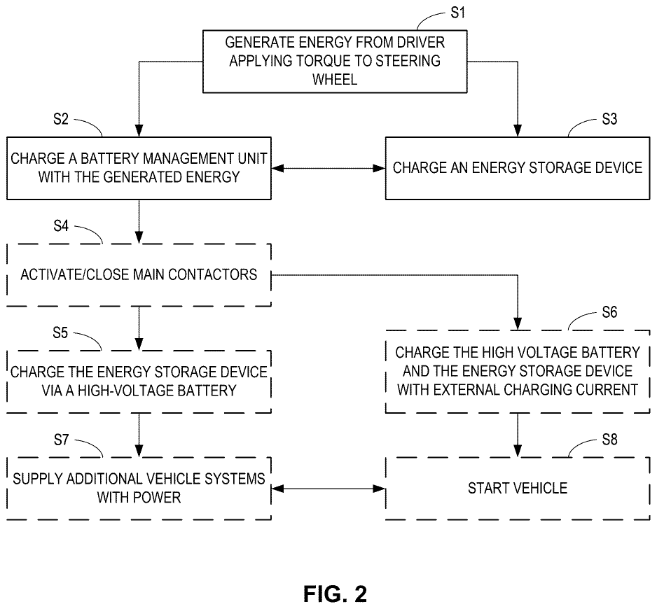

FIG. 2 shows a representation of a method 60 for the operation of an electrically powered vehicle 10 according to an example. Optional operations are shown in dashed form.

It is initially assumed that vehicle 10 experiences an operating condition which causes the main contactors 40 to be unable to be closed (e.g., activated) by the battery management unit 46. This means that a current flow between the high-voltage storage system 38 and the low-voltage electrical system 44 is prevented. This can be due to, for example, an insufficient state of charge of the battery management unit 46 and/or the energy storage device 48 of the low-voltage electrical system 44. In addition, the high-voltage battery 38 can also have an extremely low state of charge. Even if the high-voltage storage system 38 has an adequate state of charge, the main contactors 40 cannot be closed on the because of the electrical energy stored in the high-voltage storage system 38, because a current flow between the high-voltage storage system 38 and the components of the low-voltage electrical system 44 is prevented by the open main contactors 40.

To prevent the need to charge with an external charger or with a power bank, the driver therefore applies torque in operation S1 to the steering wheel 26 of the SBW steering system 14 in a deactivated mode (e.g., sleep mode, inactive mode) of the vehicle 10 in such a way that the torque causes the steering wheel to turn. As a result, electrical energy is generated in the electric motor 32 of the steering wheel actuator 30 for use by the low-voltage electrical system 44.

The example method 60 then includes operation S2, in which the battery management unit 46 is charged with the generated electrical energy until the battery management unit 46 has a state of charge greater than an initial charge threshold.

As an alternative or cumulative to operation S2, the method 60 may also include operation S3, in which the energy storage device 48 is charged with the generated electrical energy until the energy storage device 48 has a state of charge greater than a second charging threshold. Subsequently, the battery management unit 46 is then supplied with a supply current by the energy storage device 48 after the second charging threshold has been exceeded.

The exact charging strategy included in the method 60 (e.g., whether the generated energy is first used to charge the battery management unit 46 or the energy storage device 48, whereby the battery management unit 46 is then supplied with a supply current) depends on the topology of the module 12 and the low-voltage electrical system 44, as well as stored charging strategies. The charging strategy can be carried out by the battery management unit 46 itself or alternatively by the control device 34.

The advantage of operation S2 over operation S3 is also that according to operation S2, the low-voltage electrical system 44 does not always have to include a dedicated energy storage device 48. In this respect installation space and weight can be saved according to operation S2, in which the low-voltage electrical system 44 does not have to have an energy storage device 48.

In operation S3 any residual charge that may be present in the energy storage device 48 can also be used to supply the battery management unit 46 with a corresponding supply current.

In any case, as a result of operations S2 and/or S3, the battery management unit 46 is ultimately supplied with sufficient energy due to the torque applied to the steering wheel 26.

The method 60 then includes the optional operation S4, in which the main contactors 40 are closed (e.g., activated) by the battery management unit 46, so that a current flow between the high-voltage storage 38 and the DC-DC converter 42 is enabled. For example, because of the torque applied to the steering wheel 26, a current flow between the high-voltage battery 38 and the low-voltage electrical system 44 can occur without external chargers or power banks, in which the generated energy is used to close the main contactors 40.

The first charging threshold and the second charging threshold value are such that the respective energy quantities are sufficient to ensure the operation of the battery management unit 46 to the extent that the main contactors 40 can be closed. Generally, the first charging threshold and the second charging threshold are different.

The method 60 then includes the optional operation S5, in which the energy storage device 48 is charged by the high-voltage storage system 38 based on the closed main contactors 40 via the DC-DC converter 42. For this purpose, it may be necessary for the high-voltage battery 38 to have a corresponding minimum state of charge.

The method 60 can also include the optional operation S6, in which both the energy storage device 48 and the high-voltage battery 38 can be charged with an external charging current through the closed main contactors 40. Without the main contactors 40 closed, the high-voltage battery 38 cannot be charged by an external charging current. In this respect, the method 60 enables functionality of the vehicle 10, although there is initially not enough energy to close (e.g., activate) the main contactor 40.

In the optional operation S7 of the method 60, additional systems of the low-voltage electrical system 44 are supplied with a supply current by the energy storage device 48 when the state of charge of the energy storage device 48 exceeds a third charging threshold. The state of charge of the energy storage device 48 can exceed the third charging threshold by charging with an external charging current or by charging from the high-voltage storage system 38. For example, other functions of the low-voltage electrical system 44 can be reactivated, such as the starter unit 50. The third charging threshold is generally different from the first charging threshold and the second charging threshold.

In addition, the method 60 may include the optional operation S8, in which the vehicle 10 is started when the state of charge of the energy storage device 48 exceeds a first operating charge threshold and the state of charge of the high-voltage battery 38 does not fall below a second operating charge threshold. The corresponding operating charge thresholds indicate that the corresponding energy storage units of the vehicle's electrical system 10 have sufficient states of charge for the vehicle 10 to be started. The starting of the vehicle 10 can be generally ensured, for example, by the starter unit 50.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices /d/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

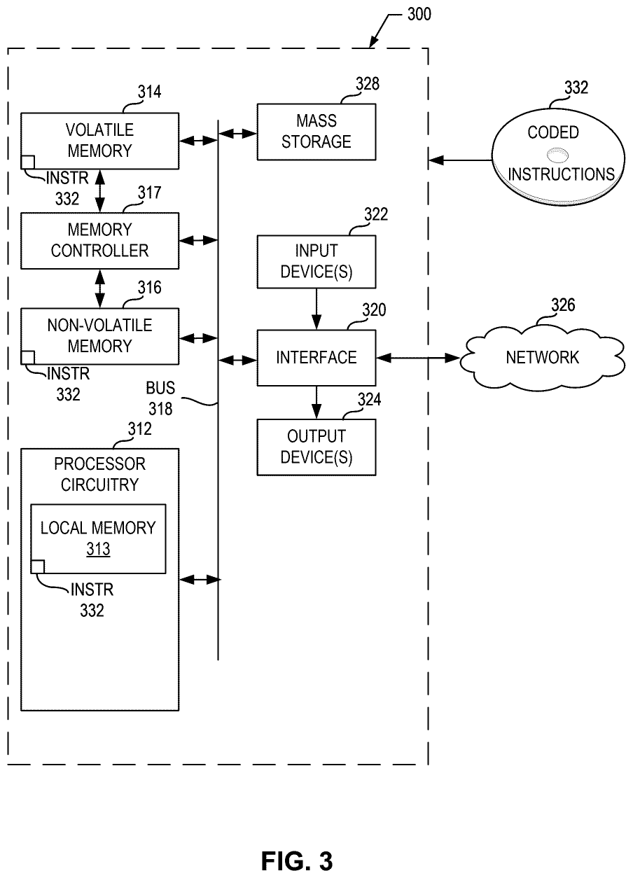

FIG. 3 is a block diagram of an example programmable circuitry platform 300 structured to execute and/or instantiate the example machine-readable instructions and/or the example operations of FIG. 2 to implement examples disclosed herein. The programmable circuitry platform 300 can be, for example, a control device, an electronic control unit (ECU), a self-learning machine (e.g., a neural network), or any other type of computing and/or electronic device.

The programmable circuitry platform 300 of the illustrated example includes programmable circuitry 312. The programmable circuitry 312 of the illustrated example is hardware. For example, the programmable circuitry 312 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 312 may be implemented by one or more semiconductor based (e.g., silicon based) devices.

The programmable circuitry 312 of the illustrated example includes a local memory 313 (e.g., a cache, registers, etc.). The programmable circuitry 312 of the illustrated example is in communication with main memory 314, 316, which includes a volatile memory 314 and a non-volatile memory 316, by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317. In some examples, the memory controller 317 may be implemented by one or more integrated circuits, logic circuits, microcontrollers from any desired family or manufacturer, or any other type of circuitry to manage the flow of data going to and from the main memory 314, 316.

The programmable circuitry platform 300 of the illustrated example also includes interface circuitry 320. The interface circuitry 320 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 322 are connected to the interface circuitry 320. The input device(s) 322 permit(s) a user (e.g., a human user, a machine user, etc.) to enter data and/or commands into the programmable circuitry 312. The input device(s) 322 can be implemented by, for example, an audio sensor, a microphone, a camera (still or video), a button, a touchscreen, and/or a voice recognition system.

One or more output devices 324 are also connected to the interface circuitry 320 of the illustrated example. The output device(s) 324 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 300 of the illustrated example also includes one or more mass storage discs or devices 328 to store firmware, software, and/or data. Examples of such mass storage discs or devices 328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 332, which may be implemented by the machine-readable instructions of FIG. 2, may be stored in the mass storage device 328, in the volatile memory 314, in the non-volatile memory 316, and/or on at least one non-transitory computer readable storage medium such as a CD or DVD which may be removable.

Example methods, apparatus, systems, and articles of manufacture to methods and apparatus for operating an electrically powered motor vehicle are disclosed herein. Further examples and combinations thereof include the following:
Example 1 includes a method for operation of a vehicle comprising applying torque to a steering wheel of the vehicle while the vehicle is in a deactivated mode to generate electrical energy in an electric motor of the vehicle, and charging an energy storage device of the vehicle with the generated electrical energy.
Example 2 includes the method of example 1, further including closing main contactors of the vehicle when a state of charge of the energy storage device is above a first threshold.
Example 3 includes the method of example 2, wherein closing the main contactors causes energy flow between a high-voltage storage device and a direct current (DC) to DC converter.
Example 4 includes the method of example 3, wherein the energy storage device is charged by the high-voltage storage device via the DC to DC converter.
Example 5 includes the method of any one or more of examples 3-4, wherein both the energy storage device and the high-voltage storage device can be charged via an external charging current.
Example 6 includes the method of any one or more of examples 3-5, wherein secondary electrical systems of the vehicle are supplied with a supply current by the energy storage device when the state of charge of the energy storage device has exceeded a second threshold.
Example 7 includes the method of any one or more of examples 3-6, wherein the vehicle can be started when the state of charge of the energy storage device exceeds the first threshold and a state of charge of the high-voltage storage device exceeds a second threshold.
Example 8 includes the method of any one or more of examples 3-7, wherein when the main contactors are open the main contactors electrically isolate the high-voltage storage device from the DC to DC converter.
Example 9 includes an apparatus for a vehicle comprising an electric motor coupled to a steering wheel, where a torque applied to the steering wheel while the vehicle is in a deactivated mode causes electrical energy to be generated, and a control device configured to cause a energy storage device of the vehicle to be charged by the generated electrical energy, and causing main contactors of the vehicle to close when a state of charge of the energy storage device exceeds a first threshold.
Example 10 includes the apparatus of example 9, wherein when the main contactors are open the main contactors electrically isolate a high-voltage storage device from a direct current (DC) to DC converter.
Example 11 includes the apparatus of any one or more of examples 9-10, wherein the main contactors can be closed by a battery management unit.
Example 12 includes the apparatus of example 10, wherein when the main contactors are closed the energy storage device is charged by the high-voltage storage device via the DC to DC converter.
Example 13 includes the apparatus of any one or more of examples 10-12, wherein the energy storage device and the high-voltage storage device can be charged via an external charging current when the main contactors are closed.
Example 14 includes the apparatus of any one or more of examples 10-13, wherein secondary electrical systems of the vehicle are supplied with a supply current by the energy storage device when the state of charge of the energy storage device exceeds a second threshold.
Example 15 includes a non-transitory computer readable storage medium comprising instructions to cause programmable circuitry to at least cause a energy storage device of a vehicle to be charged by electrical energy generated by a torque applied to an electric motor, and causing main contactors of the vehicle to close when a state of charge of the energy storage device exceeds a first threshold.
Example 16 includes the non-transitory computer readable storage medium of example 15, wherein when the main contactors are closed the energy storage device is charged by a high-voltage storage device via a direct current (DC) to DC converter.
Example 17 includes the non-transitory computer readable storage medium of example 16, wherein when the main contactors are open the main contactors electrically isolate the high-voltage storage device from the DC to DC converter.
Example 18 includes the apparatus of any one or more of examples 16-17, wherein the vehicle can be started when the state of charge of the energy storage device exceeds the first threshold and a state of charge of the high-voltage storage device exceeds a third threshold.
Example 19 includes the apparatus of any one or more of examples 16-18, wherein both the energy storage device and the high-voltage storage device can be charged via an external charging current.
Example 20 includes the apparatus of any one or more of examples 15-19, wherein secondary electrical systems of the vehicle are supplied with a supply current by the energy storage device when the state of charge of the energy storage device exceeds a second threshold.

What is claimed is:

1. A method for operation of a vehicle comprising:
applying torque to a steering wheel of the vehicle while the vehicle is in a deactivated mode to generate electrical energy in an electric motor of the vehicle; and
charging an energy storage device of the vehicle with the generated electrical energy.

2. The method of claim 1, further including closing main contactors of the vehicle when a state of charge of the energy storage device is above a first threshold.

3. The method of claim 2, wherein closing the main contactors causes energy flow between a high-voltage storage device and a direct current (DC) to DC converter.

4. The method of claim 3, wherein the energy storage device is charged by the high-voltage storage device via the DC to DC converter.

5. The method of claim 3, wherein both the energy storage device and the high-voltage storage device can be charged via an external charging current.

6. The method of claim 3, wherein secondary electrical systems of the vehicle are supplied with a supply current by the energy storage device when the state of charge of the energy storage device has exceeded a second threshold.

7. The method of claim 3, wherein the vehicle can be started when the state of charge of the energy storage device exceeds the first threshold and a state of charge of the high-voltage storage device exceeds a second threshold.

8. The method of claim 3, wherein when the main contactors are open the main contactors electrically isolate the high-voltage storage device from the DC to DC converter.

9. An apparatus for a vehicle comprising:
an electric motor coupled to a steering wheel, where a torque applied to the steering wheel while the vehicle is in a deactivated mode causes electrical energy to be generated; and
a control device configured to:
cause an energy storage device of the vehicle to be charged by the generated electrical energy; and
causing main contactors of the vehicle to close when a state of charge of the energy storage device exceeds a first threshold.

10. The apparatus of claim 9, wherein when the main contactors are open the main contactors electrically isolate a high-voltage storage device from a direct current (DC) to DC converter.

11. The apparatus of claim 9, wherein the main contactors can be closed by a battery management unit.

12. The apparatus of claim 10, wherein when the main contactors are closed the energy storage device is charged by the high-voltage storage device via the DC to DC converter.

13. The apparatus of claim 10, wherein the energy storage device and the high-voltage storage device can be charged via an external charging current when the main contactors are closed.

14. The apparatus of claim 10, wherein secondary electrical systems of the vehicle are supplied with a supply current by the energy storage device when the state of charge of the energy storage device exceeds a second threshold.

15. A non-transitory computer readable storage medium comprising instructions to cause programmable circuitry to at least:
cause an energy storage device of a vehicle to be charged by electrical energy generated by a torque applied to an electric motor; and
causing main contactors of the vehicle to close when a state of charge of the energy storage device exceeds a first threshold.

16. The non-transitory computer readable storage medium of claim 15, wherein when the main contactors are closed the energy storage device is charged by a high-voltage storage device via a direct current (DC) to DC converter.

17. The non-transitory computer readable storage medium of claim 16, wherein when the main contactors are open the main contactors electrically isolate the high-voltage storage device from the DC to DC converter.

18. The non-transitory computer readable storage medium of claim 16, wherein the vehicle can be started when the state of charge of the energy storage device exceeds the first threshold and a state of charge of the high-voltage storage device exceeds a third threshold.

19. The non-transitory computer readable storage medium of claim 16, wherein both the energy storage device and the high-voltage storage device can be charged via an external charging current.

20. The non-transitory computer readable storage medium of claim 15, wherein secondary electrical systems of the vehicle are supplied with a supply current by the energy storage device when the state of charge of the energy storage device exceeds a second threshold.
